(19) United States
(12) Patent Application Publication
(10) Pub. No.: US 2010/0027994 A1
(43) Pub. Date: Feb. 4, 2010

(54) Phase Modulation Of An Optical Orthogonal Frequency Division Multiplexing Signal

(75) Inventors: Lei Xu, Princeton, NJ (US); Yutaka Yano, Tokyo (JP); Ting Wang, West Windsor, NJ (US); Junqiang Hu, Princeton, NJ (US); Makoto Shibutani, Tokyo (JP)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 12/183,346

(22) Filed: Jul. 31, 2008

(51) Int. Cl. H04J 14/00

(52) U.S. Cl. 398/43

(57) ABSTRACT

A method includes generating an optical orthogonal frequency division multiplexing OFDM signal with in-phase and quadrature-phase components; varying an RF carrier according to the in-phase and quadrature-phase components; and modulating a phase of a lightwave carrier according to the varied RF carrier to generate an optical OFDM signal with equalized amplitude.

### BACKGROUND OF THE INVENTION

Orthogonal frequency division multiplexing (OFDM) has been applied in optical fiber communications. The diagrams 10, 11 of FIG. 1 show a generic electrical OFDM system using fast Fourier transform (FFT). The incoming high-speed data stream is demultiplexed into N sub data streams, and each of the sub data stream is modulated. The modulated sub data stream is transformed using inverted fast Fourier transform (IFFT), which converts the signal from frequency domain to time domain. With IFFT, the orthogonality of the sub carriers is naturally guaranteed. The output signal from IFFT is converted to serial data to further produce an analog signal. The RF converter modulates the generated OFDM signal over an RF carrier for signal transmission (in a wireless channel or through coaxial cable). At the receiver end, the OFDM signal is processed with FFT, which transforms the signal from time domain to frequency domain. The signal equalization module can compensate the mitigation effects from the communication channels, and therefore improve the communication quality. The signal is further demodulated and multiplexed to attain the data steam originally transmitted.

Optical OFDM signal transmission over fiber has attracted a lot of interest recently. It has shown superior tolerance to fiber chromatic dispersion (CD) and polarization mode dispersion (PMD). However, in optical OFDM signal transmissions, one of the challenging issues is caused by the large peak-to-average-power ratio (PAPR) of the electrical OFDM signals. The large PAPR can cause large peak optical power in the generated optical OFDM signals, and therefore strong fiber nonlinear effects.

With the conventional schemes, the generated optical OFDM signals for optical transmissions have relatively large power fluctuations. Different schemes have been proposed to reduce the fiber nonlinear effects during optical OFDM signal transmissions. One technique has employed signal clipping to arbitrarily reduce the PAPR of the electrical OFDM signal and intensity modulation for optical OFDM signal generation. Other proposed and demonstrated systems include: (1) intensity modulation with optical bandpass filtering at the transmitter side; (2) carrier suppressed modulation with optical bandpass filtering at the transmitter side; and (3) optical IQ modulation at the transmitter side and RF upconversion is not used. In many of these demonstrated optical OFDM systems, a low per-channel power is used for optical transmission because of the relationship between channel power and fiber nonlinear effects. However, smaller per-channel power will cause the signal to have less tolerance to amplifier noise during optical transmission.

Accordingly, there is need for a technique that reduces the fiber nonlinear effects during optical OFDM signal transmission.

### SUMMARY OF THE INVENTION

In accordance with the invention, a method includes generating an optical orthogonal frequency division multiplexing OFDM signal with in-phase and quadrature-phase components; varying an RF carrier according to the in-phase and quadrature-phase components; and modulating a phase of a lightwave carrier according to the varied RF carrier to generate an optical OFDM signal with equalized amplitude.

In another aspect of the invention, a method includes varying a phase of a lightwave carrier according to a radio frequency modulated by in-phase and quadrature phase components of an optical OFDM signal to provide a phase modulated OFDM signal with equalized amplitude to reduce fiber nonlinear effects such as increase of intensity and phase noise in fiber transmission of the phase modulated OFDM signal.

In a yet further aspect of the invention, an apparatus includes a modulator for varying a phase of a lightwave carrier according to a radio frequency modulated by in-phase and quadrature phase components of an optical OFDM signal to provide a phase modulated OFDM signal with equalized amplitude to reduce fiber nonlinear effects such as increase of intensity and phase noise in fiber transmission of the phase modulated OFDM signal.

### BRIEF DESCRIPTION OF DRAWINGS

These and other advantages of the invention will be apparent to those of ordinary skill in the art by reference to the following detailed description and the accompanying drawings.

FIG. 1 is a diagram of generic OFDM transmitter and receiver used in wireless communications that is exemplary of the prior art.

FIG. 2 is a diagram of an exemplary OFDM system illustrating use of phase modulation for OFDM signal transmission in accordance with the invention.

FIG. 3 shows diagrams of exemplary embodiments of possible phase-modulation-to-amplitude-modulation (PM-to-AM) conversion and optical-to-electrical OE conversions in accordance with the invention.

FIG. 4 is a graph of performance under fiber nonlinearities of an optical system employing phase modulation in accordance with the invention.

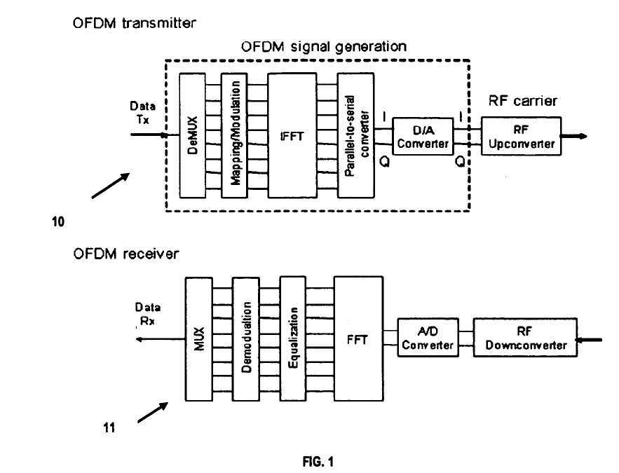

### DETAILED DESCRIPTION

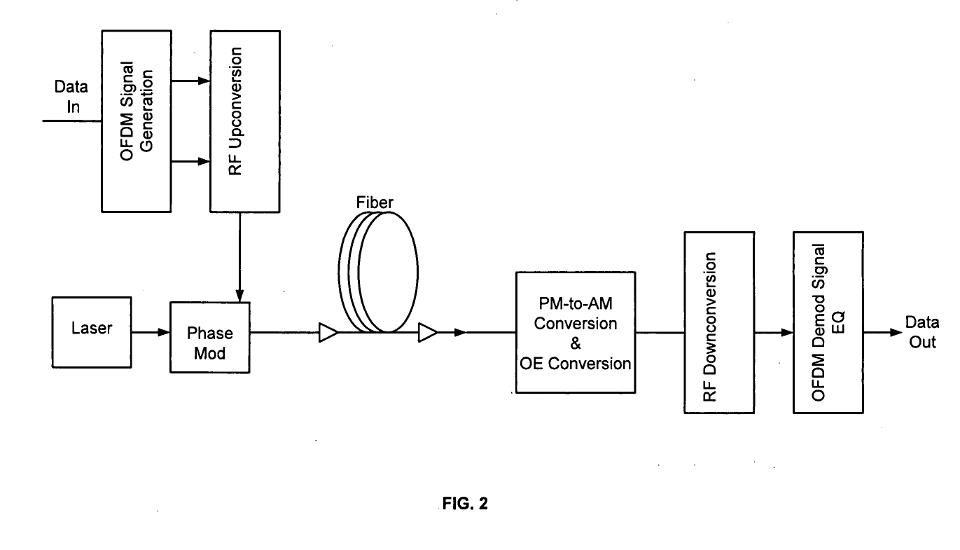

The invention is directed to using phase modulation for optical OFDM signal modulation. With phase modulation, the optical OFDM signal has uniform optical power, and therefore will have much better tolerance to fiber nonlinearity than intensity modulated signal. An exemplary OFDM system illustrating use of phase modulation in accordance with the invention is shown by the schematic diagram 20 of FIG. 2.

At the transmitter side, the generated OFDM signal out of the OFDM signal generation block 21 has two output ports: in-phase (I) and quadrature-phase (Q). In the RF upconversion block 22, the two components of the OFDM signal will modulate the RF carrier through I/Q modulation. The output signal after RF upconversion modulates the phase 24 of the lightwave carrier from the laser 23, before being amplified and sent over the fiber 26. With phase modulation, the generated optical OFDM signal has equalized amplitude. Therefore, the PAPR issue is avoided in the optical domain.

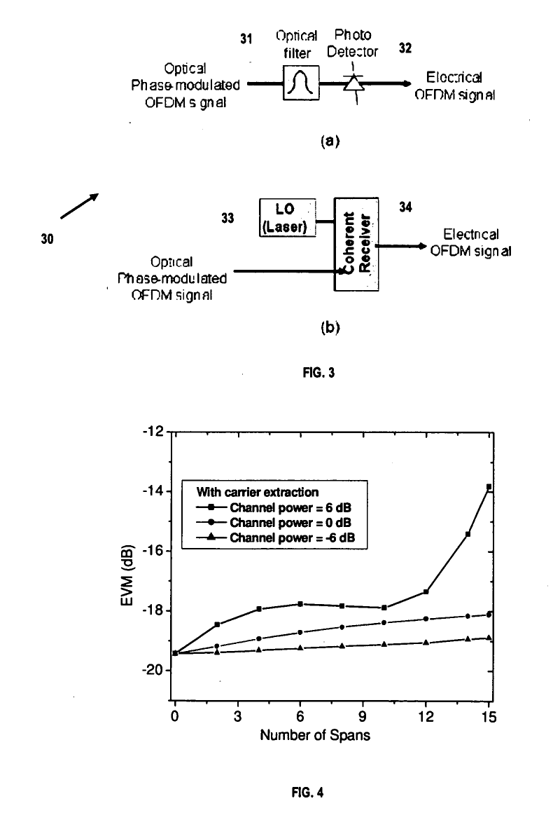

At the receiver side, the phase-modulated optical OFDM signal will be converted to intensity modulated signal through a phase-modulation-to-amplitude-modulation (PM-to-AM) conversion 27. A photo detector 32, as shown in FIG. 3(a), can change the optical signal to an electrical signal for receiving. Exemplary embodiments of possible signal PM-to-AM and optical-to-electrical OE conversions are diagrammed 30 in FIGS. 3 (a) and (b).

The phase-modulation-to-amplitude-modulation embodiment of 3(a) employs narrow band optical on the optical phase modulated OFDM signal. The phase-modulation-to-amplitude-modulation embodiment of 3(b) employs coherent reception 34 in conjunction with a local oscillator LO laser source 33 on the optical phase modulated OFDM signal. With the coherent detection, the optical carrier signal (acting as a local oscillator in FIG. 3(b)) can also be extracted from the incoming phase modulated signal.

In contrast to the inventive feature of pure optical phase modulation, the conventional use of optical OFDM signals with intensity modulations can have large signal peak power because OFDM signals usually have large PAPR, which can cause large fiber nonlinear effects. Fiber nonlinear effects can cause increase of intensity and phase noise. To minimize the fiber nonlinear effect, many of the demonstrated optical OFDM systems use small per-channel power.

With the inventive pure optical phase modulation, which results in equalized optical power, the system can be expected to have larger tolerance to fiber nonlinear effect. The graph of FIG. 4 shows the transmission performance with different numbers of standard single mode fiber SSMF spans when self carrier extraction is used. Amplifier noise is not included. With per-channel power of 0 dBm, the signal EVM penalty caused by fiber nonlinearity is about 1.5 dB after 1200 km of SSMF transmission. Compared with many of the demonstrated systems, where the per-channel power is in the range of −3 dBm to −7 dBm, a system employing the inventive phase modulation can have a much larger per-channel power. A larger per-channel power generally can increase the optical-signal-to-noise ratio (OSNR) after long distances of fiber transmissions, and simplify the optical amplification schemes. For example, when the optical signal has poor tolerance to fiber nonlinearity, a low per-channel power and high-performance optical amplification schemes, like Raman amplification, are used to support long-haul transmissions.

The present invention has been shown and described in what are considered to be the most practical and preferred embodiments. It is anticipated, however, that departures may be made therefrom and that obvious modifications will be implemented by those skilled in the art. It will be appreciated that those skilled in the art will be able to devise numerous arrangements and variations which, not explicitly shown or described herein, embody the principles of the invention and are within their spirit and scope.

What is claimed is:

1. A method comprising the steps of:
generating an optical orthogonal frequency division multiplexing OFDM signal with in-phase and quadrature-phase components;
varying an RF carrier according to the in-phase and quadrature-phase components; and
modulating a phase of a lightwave carrier according to the varied RF carrier to generate an optical OFDM signal with equalized amplitude.

2. The method of claim 1, wherein the step of modulating provides an optical OFDM signal with equalized optical power.

3. The method of claim 1, wherein the modulating provides an optical OFDM signal with equalized optical power that increases tolerance to fiber nonlinear effects such as increase of intensity and phase noise.

4. The method of claim 1, further comprising the step of converting the received phase modulated optical OFDM signal to an amplitude modulated signal.

5. The method of claim 4, wherein the step of converting comprises optical filtering of the optical phase modulated OFDM signal.

6. The method of claim 5, wherein the optical filtering comprises one of a single pass band, a periodic pass band and a tunable pass band.

7. The method of claim 4, wherein the step of converting comprises coherent reception of the optical phase modulated OFDM signal.

8. A method comprising the step of varying a phase of a lightwave carrier according to a radio frequency modulated by in-phase and quadrature phase components of an optical OFDM signal to provide a phase modulated OFDM signal with equalized amplitude to reduce fiber nonlinear effects such as increase of intensity and phase noise in fiber transmission of the phase modulated OFDM signal.

9. The method of claim 8, further comprising the step of converting the phase modulated OFDM signal to an intensity modulated.

10. An apparatus comprising a modulator for varying a phase of a lightwave carrier according to a radio frequency modulated by in-phase and quadrature phase components of an optical OFDM signal to provide a phase modulated OFDM signal with equalized amplitude to reduce fiber nonlinear effects such as increase of intensity and phase noise in fiber transmission of the phase modulated OFDM signal.

11. The apparatus of claim 10, further comprising a converter for changing the phase modulated optical OFDM signal to amplitude modulated optical OFDM signal.

12. The apparatus of claim 12, wherein the converter comprises an optical filter.
